(19) United States
(12) Patent Application Publication
(10) Pub. No.: US 2019/0333031 A1
(43) Pub. Date: Oct. 31, 2019

(54) SYSTEM, METHOD, AND COMPUTER PROGRAM PRODUCT FOR VALIDATING BLOCKCHAIN OR DISTRIBUTED LEDGER TRANSACTIONS IN A SERVICE REQUIRING PAYMENT

(71) Applicant: Dark Matter L.L.C., Dubai (AE)

(72) Inventor: David William Kravitz, San Jose, CA (US)

(21) Appl. No.: 16/002,984

(22) Filed: Jun. 7, 2018

Related U.S. Application Data
(63) Continuation of application No. 15/963,943, filed on Apr. 26, 2018.

(51) Int. Cl. G06Q 20/06; G06Q 20/40

(52) U.S. Cl. CPC G06Q 20/06; G06Q 20/401

(57) ABSTRACT

A system, method, and computer program product are provided for validating blockchain or distributed ledger transactions in a service requiring payment. In use, a transaction submitted within a blockchain or distributed ledger is accessed, the transaction being submitted for provisioning a service that requires payment. Additionally, one or more assertions of device or user attributes that are verifiably associated with at least one party to the transaction are extracted from the transaction. Further, the transaction is validated, utilizing the device or user attributes, independently of processing the payment.

### RELATED APPLICATION(S)

This application is a continuation of U.S. patent application Ser. No. 15/963,943 filed Apr. 26, 2018, the entire contents of which are incorporated herein by reference.

### FIELD OF THE INVENTION

The present invention relates to executing transactions within a service, and more particularly to executing transactions within a blockchain or distributed ledger.

### BACKGROUND

Credible reputation lies at the core of users and devices electronically communicating and transacting successfully. In critical infrastructure and public safety applications, as well as day-to-day personal and business transactions, it is imperative to have a significant degree of confidence in whom/what one communicates with—whether to know if the recipient can be entrusted with the sender's data, or if the sender's data is to be considered reliably sourced. Even where possible, lost reputation is substantially more cumbersome, time-consuming and expensive to replace than are compromised, stolen or defective devices and their embedded cryptographic keys. However, identity fraud, which can result in lost reputation, is becoming increasingly difficult to manage, especially for example in the face of massive-scale database breaches.

Furthermore, reputation metrics play a vital role in enabling a highly scalable and responsive concurrent- or post-service-delivery payment reconciliation model. Reputation of devices and of users may be dependent upon perceived device robustness (which may change during the life-cycle of a given instance of a device), payment timeliness, and service performance timeliness, completeness and accuracy. However, current techniques related to validation of transactions specifically in blockchain- and distributed ledger-based services, especially which require payment, have not effectively utilized attributes indicative of reputation for validation purposes.

There is thus a need for addressing these and/or other issues associated with the prior art.

### SUMMARY

A system, method, and computer program product are provided for validating blockchain or distributed ledger transactions in a service requiring payment. In use, a transaction submitted within a blockchain or distributed ledger is accessed, the transaction being submitted for provisioning a service that requires payment. Additionally, one or more assertions of device or user attributes that are verifiably associated with at least one party to the transaction are extracted from the transaction. Further, the transaction is validated, utilizing the device or user attributes, independently of processing the payment.

### BRIEF DESCRIPTION OF THE DRAWINGS

FIG. 1 shows a method for validating blockchain or distributed ledger transactions in a service requiring payment, in accordance with one embodiment.

FIG. 2 shows a method for combining permissioned and permissionless transactions within a blockchain or distributed ledger, in accordance with another embodiment.

FIG. 3 shows a method for combining permissioned and permissionless blockchains or distributed ledgers, in accordance with another embodiment.

FIG. 4 shows a conceptual illustration of a system for processing blockchain or distributed ledger transactions in a service requiring payment, in accordance with yet another embodiment.

FIG. 5 shows a method for using votes or reviews in association with transactions in a blockchain or distributed ledger, in accordance with still yet another embodiment.

FIG. 6 illustrates a network architecture, in accordance with one embodiment.

FIG. 7 illustrates an exemplary system, in accordance with one embodiment.

### DETAILED DESCRIPTION

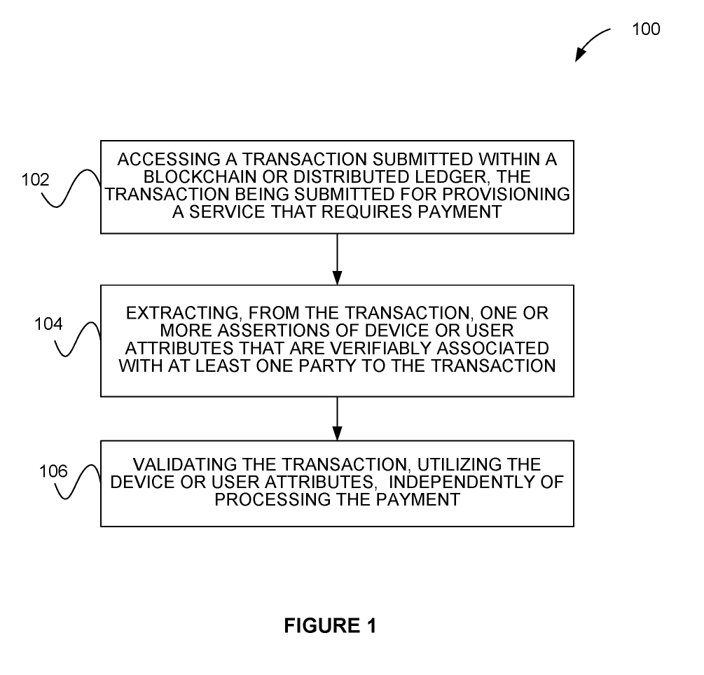

FIG. 1 shows a method 100 for validating blockchain or distributed ledger transactions in a service requiring payment, in accordance with one embodiment. In the context of the present description, a blockchain refers to blocks, such as transactions, records, or other objects, that are linked and secured within one or more computer systems. For example, the blocks may be secured using cryptography, where each block contains a cryptographic hash of the previous linked block. Each block may further contain a timestamp and/or transaction data.

Also in the context of the present description, a distributed (or shared) ledger refers to replicated, shared, and synchronized digital data across multiple different network nodes, such as computer systems (which may be geographically distributed). One example of the distributed ledger may be the blockchain mentioned above, but it should be noted that other distributed ledgers may also be of a type of data structure different from the blockchain. Thus, the distributed ledger may also consist of transactions, records, or other objects, which may or may not be linked within the distributed network nodes.

As shown in operation 102, a transaction submitted within a blockchain or distributed ledger is accessed, the transaction being submitted for provisioning a service that requires payment. The service can be a telecommunications service, a medical service, or any other type of service capable of being implemented through a computer system in which payment is required in exchange for the service being provisioned (e.g. deployed, supplied, executed, etc.).

In one embodiment, the transaction is a request for the provisioning of the service. In another embodiment, the transaction is a response to a request for the provisioning of the service. In other embodiments the transaction itself may provision any portion of the service. Further, the transaction may be submitted by a user or automatically by a computer system (e.g. as part of the blockchain or other process), and may be accessed within the blockchain or distributed ledger.

Additionally, as shown in operation 104, one or more assertions of device or user attributes that are verifiably associated with at least one party to the transaction are extracted from the transaction. The assertions may be any indication of the device or user attributes that are included in the transaction itself. In one embodiment, the device or user attributes may be reputation scores for the associated party to the transaction. It should be noted that the party to the transaction may be a creator of the transaction, an intended recipient of the transaction, a counterparty to the transaction, etc.

Further, as shown in operation 106, the transaction is validated, utilizing the device or user attributes, independently of processing the payment. For example, the payment may be processed by another transaction within the blockchain or distributed ledger. However, since the transaction includes the device or user attributes which are verifiably associated with at least one party to the transaction, the transaction can be validated independently of processing the payment.

In one embodiment, validating the transaction may include comparing the device or user attributes to one or more stipulations (e.g. criteria predefined for the blockchain or distributed ledger). Optionally, the one or more stipulations may be set (i.e. configured, defined, etc.) by the transaction, a prior transaction submitted within the blockchain or distributed ledger, a policy, etc. A transaction may be validated when the stipulations are met by the device or user attributes, and may be invalidated when stipulations are not met by the device or user attributes.

Validation of the transaction may be performed as a prerequisite of processing the transaction. Thus, responsive to validating the transaction, the transaction may be processed (e.g. executed, etc.) within the blockchain or distributed ledger. Optionally, may validators verify through message authentication code computation guesses of the device or user attributes via selective release by a creator of the transaction of integrity keys for the device or user attributes. As another option, validators may recover through decryption the device or user attributes via selective release by a creator of the transaction of encryption keys for the device or user attributes. As a further option, validators may recover through decryption the device or user attributes via recovery of encryption keys through knowledge of audit-level keys.

In other optional embodiments, the device or user attributes can indicate conditions that must be met through attributes possessed by other transaction counterparties within the blockchain or distributed ledger, as prerequisite to the transaction being considered valid. Such conditions may be incorporated as part of an attribute that indicates the transaction type, so that a transaction creator cannot effectively withhold disclosure of such conditions without also withholding the transaction type. Such attributes may be possessed by the transaction creator or by other counterparties to the transaction. In one embodiment, such attributes may be incorporated into transaction certificates, such as a signature transaction certificate (TCert) of a transaction creator and/or a key agreement transaction certificate (TCert) of an intended recipient or counterparty to the transaction.

When acquiring key agreement TCerts owned by other users/devices, a user/device may also acquire [at the discretion of the Transaction Certificate Authority (TCA), that TCert owner or other providing entity] one or more keys that selectively release certain attributes of such key agreement TCerts. Such keys can later be forwarded for use in the transaction validation and or to other recipients within a transaction created by the user/device that acquired the key agreement TCerts. In some instances, selective disclosure or release is not necessary because validation is performed by or with the assistance of an entity that has possession of one or more audit-level keys that enable recovering attributes from TCerts without necessarily entailing selective disclosure or release of keys used to decrypt encrypted attributes contained within key agreement TCerts.

More illustrative information will now be set forth regarding various optional architectures and features with which the foregoing framework may or may not be implemented, per the desires of the user. It should be strongly noted that the following information is set forth for illustrative purposes and should not be construed as limiting in any manner. Any of the following features may be optionally incorporated with or without the exclusion of other features described.

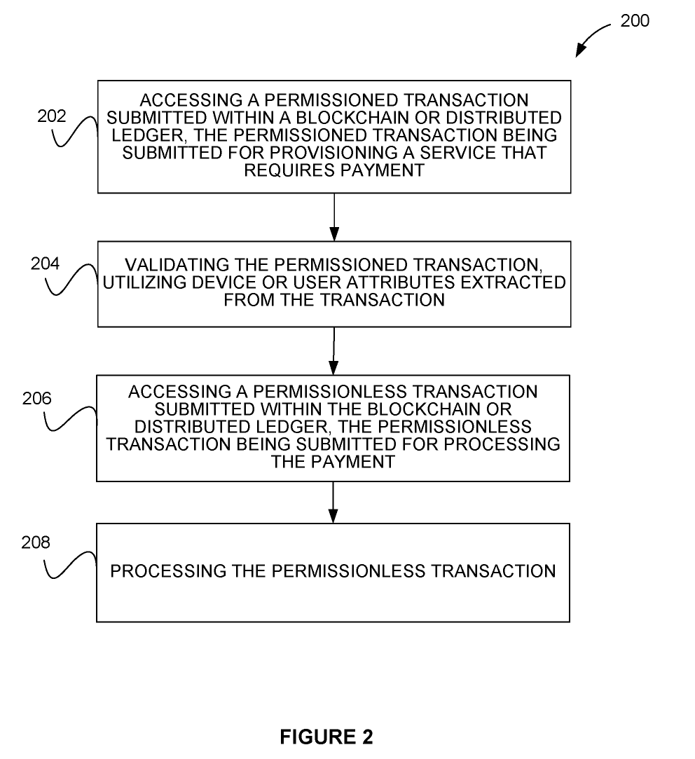

FIG. 2 shows a method 200 for combining permissioned and permissionless transactions within a blockchain or distributed ledger, in accordance with another embodiment. As an option, the method 200 may be carried out in the context of the method 100 of FIG. 1. Of course, however, the method 200 may be carried out in any desired context. It should also be noted that the aforementioned definitions may apply during the present description.

As shown in operation 202, a permissioned transaction submitted within blockchain or distributed ledger is accessed, where the permissioned transaction is submitted for provisioning a service that requires payment. In the context of the present embodiment, the permissioned transaction refers to a transaction that requires validation via the user or device attributes included therein. For example, the transaction described with reference to operation 102 of FIG. 1 is an exemplary embodiment of a permissioned transaction.

As shown in operation 204, the permissioned transaction is validated, using user or device attributes extracted therefrom. Thus, the permissioned transaction may be configured to include the user or device attributes, which are usable for validating the transaction. Operation 204 may be accomplished in accordance with operations 104-106 of FIG. 1 described above.

Additionally, as shown in operation 206, a permissionless transaction submitted within the blockchain or distributed ledger is accessed, where the permissionless transaction is submitted for processing the payment. In the context of the present embodiment, the permissionless transaction refers to a transaction that does not require validation via user or device attributes included therein.

In operation 208, the permissionless transaction is processed.

It should be noted that while operations 202-208 refer to one permissioned transaction and one permissionless transaction, the blockchain or distributed ledger described herein may include one or more permissioned and/or permissionless transactions, which may be processed by the method as described herein. For example, one or multiple permissioned transactions may be included for individually or compositely provisioning the service, and similarly one or multiple permissionless transactions may be included for individually or compositely addressing the payment processing.

In an alternative embodiment, a transaction that is used for payment processing may be permissioned rather than permissionless. It may include updating a state associated with at least one source account and at least one sink account. Optionally, the at least one source account and the at least one sink account may be identifiable via one or more assertions of device or user attributes that are verifiably associated with at least one party to a permissioned transaction used for payment processing.

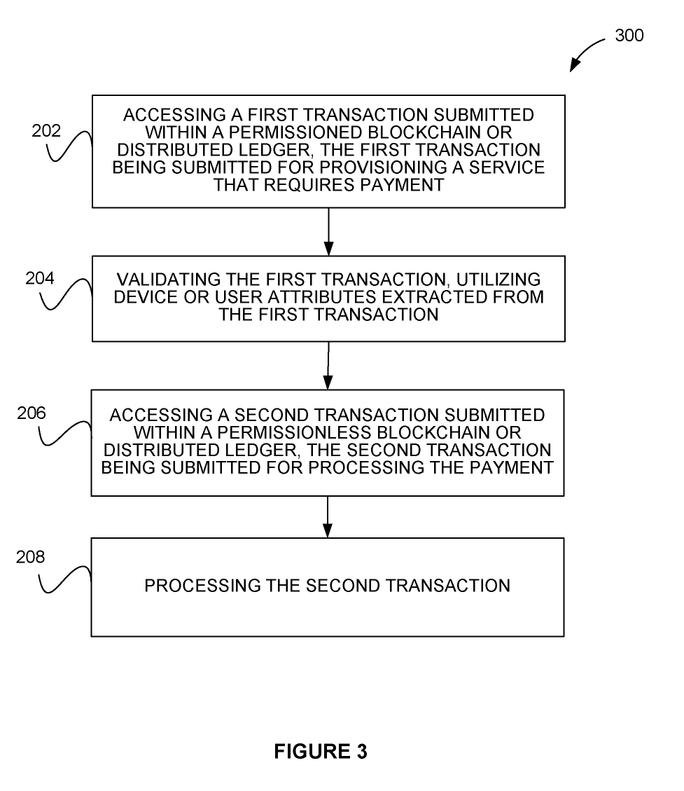

FIG. 3 shows a method 300 for combining permissioned and permissionless blockchains or distributed ledgers, in accordance with another embodiment. As an option, the method 300 may be carried out in the context of the method 100 of FIG. 1. Of course, however, the method 300 may be carried out in any desired context. It should also be noted that the aforementioned definitions may apply during the present description.

As shown in operation 302, a first transaction submitted within permissioned blockchain or distributed ledger is accessed, where the first transaction is submitted for provisioning a service that requires payment. In the context of the present embodiment, the first transaction refers to a transaction that requires validation via the user or device attributes included therein. For example, the transaction described with reference to operation 102 of FIG. 1 is an exemplary embodiment of the first transaction.

As shown in operation 304, the first transaction is validated, using user or device attributes extracted therefrom. Thus, the first transaction may be configured to include the user or device attributes, which are usable for validating the transaction. Operation 304 may be accomplished in accordance with operations 104-106 of FIG. 1 described above.

Additionally, as shown in operation 306, a second transaction submitted within a permissionless blockchain or distributed ledger is accessed, where the second transaction is submitted for processing the payment. In the context of the present embodiment, the second transaction refers to a transaction that does not require validation via user or device attributes included therein. Furthermore, the permissionless blockchain or distributed ledger may include a native cryptocurrency usable for processing the payment, as an option.

In operation 308, the second transaction is processed.

It should be noted that while operations 302-308 refer to one transaction within the permissioned blockchain or distributed ledger and one transaction within the permissionless blockchain or distributed ledger, these blockchains or distributed ledgers may respectively include one or more transactions, which may be processed by the method as described herein. For example, one or multiple transactions may be included in the permissioned blockchain or distributed ledger for individually or compositely provisioning the service, and similarly one or multiple permissionless transactions may be included in the permissionless blockchain or distributed ledger for individually or compositely addressing the payment processing.

In an alternative embodiment, the second transaction may be included within a permissioned blockchain. The second transaction may include updating a state associated with at least one source account and at least one sink account. Optionally, the at least one source account and the at least one sink account may be identifiable via one or more assertions of device or user attributes that are verifiably associated with at least one party to the second transaction. The second permissioned blockchain may be distinct from or the same as the first permissioned blockchain.

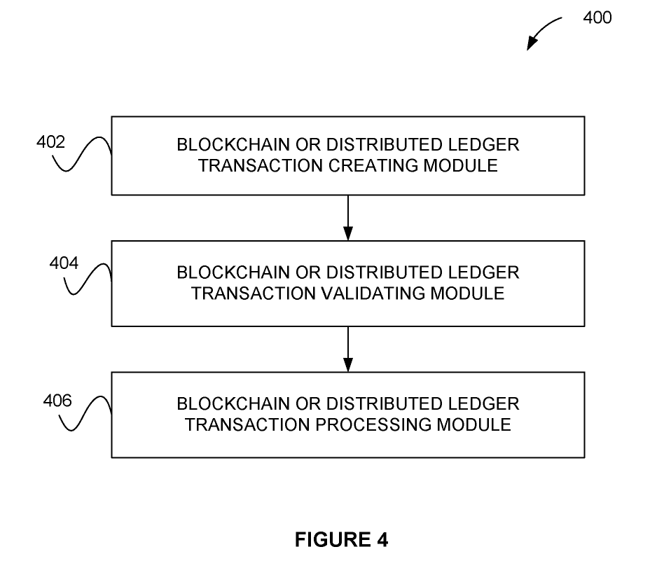

FIG. 4 shows a conceptual illustration of a system 400 for processing blockchain or distributed ledger transactions in a service requiring payment, in accordance with yet another embodiment. As an option, the system 400 may be implemented in the context of the previous figures. Of course, however, the system 400 may be carried out in any desired context.

As shown, a blockchain or distributed ledger transaction creating means in the form of a blockchain or distributed ledger transaction creating module 402 is provided for configuring a transaction submitted within a blockchain or distributed ledger to include one or more assertions of device or user attributes that are verifiably associated with at least one party to the transaction, where the transaction is being submitted for provisioning a service that requires payment. In various embodiments, the blockchain or distributed ledger transaction creating module 402 may include at least one processor (to be described later) and any software controlling the same, and/or any other circuitry capable of the aforementioned functionality.

Also included is a blockchain or distributed ledger transaction validating means in the form of a blockchain or distributed ledger transaction validating module 404 in communication with the blockchain or distributed ledger transaction creating module 402 for accessing the transaction submitted within the blockchain or distributed ledger and including the device or user attributes, extracting therefrom the one or more assertions of device or user attributes, and validating the transaction, utilizing the device or user attributes, independently of processing the payment. In various embodiments, the blockchain or distributed ledger transaction validating module 404 may include at least one processor (to be described later) and any software controlling the same, and/or any other circuitry capable of the aforementioned functionality.

With continuing reference to FIG. 4, blockchain or distributed ledger transaction processing means in the form of blockchain or distributed ledger transaction processing module 406 is in communication with the blockchain or distributed ledger transaction validating module 404 for processing the transaction responsive to validation thereof. In various embodiments, blockchain or distributed ledger transaction processing module 406 may include at least one processor (to be described later) and any software controlling the same, and/or any other circuitry capable of the aforementioned functionality.

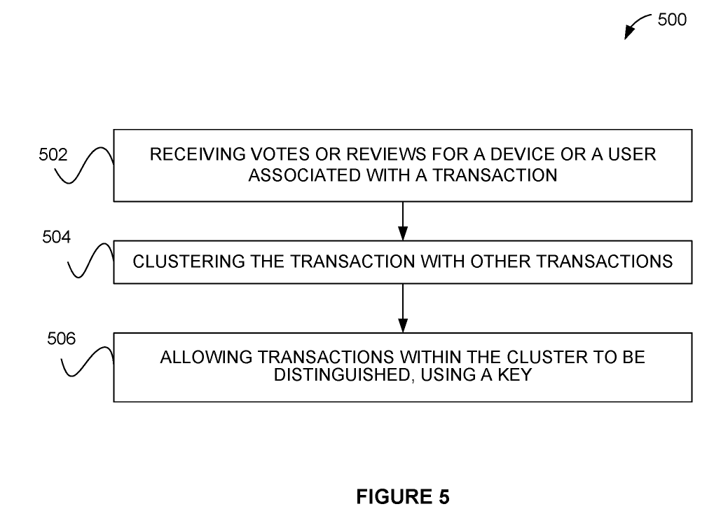

FIG. 5 shows a method 500 for using votes or reviews in association with transactions in a blockchain or distributed ledger, in accordance with still yet another embodiment. As an option, the method 500 may be carried out in the context of any of the previously described figures. Of course, however, the method 500 may be carried out in any desired context. It should also be noted that the aforementioned definitions may apply during the present description.

As shown in operation 502, votes or reviews for a device or a user associated with a transaction are received. The votes or reviews may be indicative of a reputation of the device or user (e.g. may be reputation scores). Additionally, as shown in operation 504, the transaction is clustered with other transactions. Further, as shown in operation 506, transactions within the cluster are allowed to be distinguished, using a key. For example, the transactions may be distinguished by originating device or user from a plurality of devices or users. As another example, the transactions may be distinguished by votes or reviews referring to a same device or user from the plurality of devices or users. Optionally, each device or user in the plurality of devices or users may exhibit a one-time user persona to the other devices or users in the plurality of devices or users in lieu of static identifiers.

### Exemplary Embodiment 1

A transaction within a blockchain or distributed ledger involves telemedicine, or more specifically, remote activation of prescribed dosage of a drug such as via an intravenous/IV apparatus. Such IV apparatus or other dispensing equipment may be locked down so as to prevent triggering to release the flow of medication in the absence of legitimate and fresh authorization. Such authorization may be transmitted and received remotely, potentially asynchronously, such as via a blockchain transaction that is submitted by or on behalf of the prescribing physician. Such dispensing equipment may be in a hospital, clinic or patient's residence, as examples. Although validation of the transaction does not involve consideration of processing of payment(s) for the service(s) being prescribed or offered, there may be consideration of likelihood that one or more such payments will be appropriately handled. For example, there may be validation that checks whether the patient to be treated has a user attribute that indicates current insurance coverage that is acceptable to the prescribing physician's practice and/or the hospital or clinic. There may be further or alternative validation of an attribute comprising a reputation score that reflects the patient's history of timeliness of payments due for health-related services (whether paid by patient as balance after insurance company payments to health service providers or paid by patient in-lieu of carrying an insurance policy). This can be implemented using the cryptographic structures in “Securing User Identity and Transactions Symbiotically: IoT Meets Blockchain” by D. W. Kravitz and J. Cooper, 2017 Global Internet of Things Summit (GIoTS), Geneva, 2017, pp. 1-6; and “Transaction Immutability and Reputation Traceability: Blockchain as a Platform for Access-controlled IoT and Human Interactivity” to be published online in IEEE Xplore, final/post conference proceedings of Privacy, Security and Trust (PST) 2017—the ISBN-13 of the proceedings is going to be 978-1-5386-2487-6 (was submitted for publication review on 20 Sep. 2017)—Author: David William Kravitz, Dark Matter.”

“Transaction Immutability and Reputation Traceability: Blockchain as a Platform for Access-controlled IoT and Human Interactivity” discloses “Although we relied on key management that securely and efficiently addresses passive authorized auditability simultaneously with selective release of proof-of-possession of attributes, and reused such auditability mechanism for analytics processing that is necessary for reputation score updating, we did not recapitulate here these structures that were previously detailed in [2] and [3].”—where cited reference [2] is D. Kravitz, J. Cooper, “Securing User Identity and Transactions Symbiotically: IoT Meets Blockchain,” IEEE Global Internet of Things Summit (GIoTS) 2017, June 2017, and cited reference [3] is D. Kravitz, US Patent Publication No. 2017/0147808, “Tokens for Multitenant Transaction Database Identity, Attribute and Reputation Management.” Furthermore, “Securing User Identity and Transactions Symbiotically: IoT Meets Blockchain” includes, in particular, the following reference citations: [6] https://github.com/hyperledger/hyperledger/blob/master/presentations/2016-06-23_Hyperledger%20Membership%20Services%20Presentation.pdf and https://github.com/hyperledger/hyperledger/blob/master/presentations/2016-07-13_MembershipServicesInHyperledgerFabric_Part2.pdf.

### Exemplary Embodiment 2

A transaction generated by a transaction creator within the context of a permissioned blockchain can specify the means by which an intended recipient of such transaction should later pay that transaction creator by submitting a transaction within the context of a permissionless cryptocurrency blockchain. One way to do this involves the transaction creator incorporating a function of a public key or other cryptocurrency address into the permissioned blockchain transaction that is later used by the intended recipient to direct to whom/what the cryptocurrency transaction should result in payment. In one preferred embodiment, the transaction creator uses a signature TCert on the permissioned blockchain where the signature verification public key of that TCert is to later be used by the intended recipient to direct or route payment via the cryptocurrency blockchain.

### Exemplary Embodiment 3

One embodiment of a method of transacting via a blockchain entails the following: A resource-constrained sensor node communicates locally (e.g., via Bluetooth Low Energy (BLE)) with devices that are capable of acting as proxies in order to forward communications from the sensor node to an intended end recipient system node. Such forwarding of communications occurs via a blockchain transaction. The sensor node can be provisioned with keys that enable end-to-end secured communications. For example, a symmetric message authentication code (MAC) key can be used along with a symmetric encryption key in order to efficiently provide data integrity and confidentiality capabilities, respectively. Communications/data processed using such key(s) is included within the blockchain transaction. Within such data, there can be an additional field that specifies the ID of the current device, as well as the IDs of devices that the sensor node most recently interacted with. Such data may also include a counter value that can later be used by the end recipient system node to detect missing communications. The blockchain validation procedure can check the device's current reputation score (included as an attribute or as a qualifier of an attribute of the transaction creator). Determination of the validity status of the transaction can be based, at least in part, on comparing the reputation score against the minimum threshold set by the business logic/policy that applies to this application/use case. The end recipient system node can check missing counter values against the devices that had been designated as proxies to deliver the sensor node's communications via the blockchain. Such absence, if any, may result in downgrading of that device's reputation score. The end recipient system node, as intended recipient of the transaction, may also have a reputation score that reflects its history of providing payments to devices that have successfully participated in forwarding communications from one or more sensor nodes. Such reputation score of the end recipient node may be checked by the blockchain validation procedure, possibly against a minimum threshold set by the relevant business logic. Alternatively, or additionally, such reputation score of the end recipient node may be checked by a device capable of acting as a proxy, where, dependent on such reputation score, the device may refuse to act as a proxy. Such refusal may occur initially, while in communication with the sensor node, or after such communication but aborting prior to submitting a transaction to the blockchain.

Note that the embodiment immediately above only involves transacting via a blockchain in response to a request, where, in accommodation of the constrained nature of the sensor node, the request that a service be provided does not entail transacting via a blockchain. In other embodiments of transacting via a blockchain, a request may involve transacting via a blockchain while a response may not. In still other embodiments of transacting via a blockchain, a request and a response may each involve transacting via a blockchain. The entity that requests that a service be provided need not be the entity responsible for ultimately paying for such provided service or directing that payment be processed or provided. In the embodiment above, an end recipient node may be responsible for providing payment or directing that such payment be provided. Note that in some cases payments may be aggregated. For example, a plurality of distinct sensor nodes may each independently request that a same particular device act as proxy for delivery of communications to an end recipient system node that is common to all such requests. A payment done by or on behalf of that end recipient system mode may reflect the cumulative service performed by the particular device across all such sensor nodes.

### Exemplary Embodiment 4

An app on a phone/wearable only allows the private key (associated with the public key within the certificate issued during enrollment of the user) to be utilized if it is activated (at preset frequency/periodicity) by a biometric that has been associated with the user via the credentials that were used to initialize the user's digital identity. Such biometric type must be compatible with the hardware/firmware of the phone/wearable, such as a fingerprint sensor or other means of inputting (preferably relatively user-unique and preferably difficult-to-spoof) body function measurements. This does more than protect the user's profile against misappropriation by an impostor who has stolen the phone/wearable. It also prevents the legitimate user from lending use of their profile to someone else by lending that person their phone/wearable. Why is this important?—One use case is to establish patterns of demonstrably user-owned activity on the blockchain that can be securely released by the user to show to a bank, credit card company, law enforcement agency, etc. in order to establish their innocence/alibi relative to involvement in fraudulent/illegal activities—since the user is shown to be somewhere else at the time of suspect activity. A more specific aspect of such use case can have an embodiment as follows: When phone/wearable is in proximity to trusted roadside units, it submits transactions to the blockchain that incorporate, in particular, the pseudo-random challenges that are regularly generated and transmitted locally by such roadside units. Such transactions also incorporate the static ID of the particular roadside unit. A trusted authority can later verify the authenticity by reproducing the same roadside unit-specific pseudo-random challenges. Even if the phone/wearable misrepresents the time at which such pseudo-random challenge transmission was received, the sequencing of transactions on the blockchain will contradict such misrepresentation. The locations of the identified (stationary) roadside units are known to the trusted authority. This use case can be combined with the operation of driverless cars in which the user is a passenger, as the driverless car interacts with roadside units for unrelated reasons (such as for safe distancing between vehicles/accident-prevention/response, and dynamic vehicular traffic routing).

An alternative method to that immediately above offers a potential improvement upon device-dependent biometrics, as it does not require integration with the device or compatibility of a device-generated biometric template with a biometric template generated at a registration authority possibly using disparate equipment: Suppose the credentials that were used to initialize the user's digital identity included one or more photos of the user that were previously taken at the time of in-person registration of the user, such as for issuance of a driver's license or identity card. A one-way hash of such photo(s) is included within the issued enrollment certificate and/or another means is used to associate the photo(s) with the user's enrollment. The user may be enrolled on multiple devices. Preferably securely-provisioned cameras located at certain known stationary infrastructure points can be used to take photo(s) of a device user that are transmitted within proximity to that device using local communications (such as BLE). The device's app preferably allows only relatively immediate/short-term access to or use of the private key associated with the subject public key of the enrollment certificate (and/or of any keys derived from such private key) only if, using an edge computing algorithm, the photo(s) received from the stationary camera are determined to be a close enough match to the photo(s) that have been associated with the user at the time of enrollment. Use/knowledge of the enrollment private key is required in order to successfully generate a transaction that represents the device user. Preferably, the generated transaction is not locally storable or exportable for delayed submission to the blockchain. This method can be made subject to audit as follows: The photo(s) data and preferably additionally a timestamp is digitally signed by the camera. Such signed data or a one-way function thereof can be included within the transaction submitted to the blockchain by the device. The public key used to verify the camera's digital signature is known to be associated with the particular camera. With regard to proximity, the device's location at the time of submitting the blockchain transaction may be further corroborated (as being in the vicinity of the stationary camera) by other devices with which that device communicates proximally (potentially off-chain) at that time (such as with respect to relatively co-located performance of a joint task). Possibly in addition to the device itself, such other devices may transact on the (timestamped-by-consensus) blockchain, where such transactions may refer to that device. The reference to that device may be through that device's static identifier or through a pseudonymous identifier used by that device. The ownership of such static or pseudonymous identifier may be verified as corresponding to an attribute of the device. Proper implementation of proximity detection guards against acceptance of photos that are taken by a camera that is remote from the device that is comparing them against the photos associated with enrollment (or at least against ultimate acceptance of blockchain transactions the generation of which is enabled in this way by a remote camera). Use may be made of a nonce that is randomly or pseudorandomly generated by the device, then transmitted or otherwise made available to the camera, and enforced by the device to be included or otherwise unambiguously referenced within the verifiably signed message received from the camera within a specified round-trip-time as a condition of the response being considered acceptable by the device. Further specificity/elaboration/modification within the embodiment above can be added in order to accommodate certain circumstances or features. For example, it may be appropriate to differentiate between allowing access to an enrollment private key or to keys derived from such enrollment private key for the purpose of computing the generation of transactions vs. other uses of such keys (such as to process transactions that already exist on the blockchain). It may be appropriate to default to use of the device's internal camera or other available mechanisms when the use of stationary cameras or similar infrastructure is not readily available.

### Exemplary Embodiment 5

In an embodiment pursuant to the method of FIG. 5, since an Analytics Processor (AP) to which individual votes are targeted can be audited, and thus be required to turn over (symmetric) keys used to encrypt (using an authenticated encryption method) peer-contributed digitally signed votes/reviews/endorsements that cannot feasibly be spoofed/altered by the AP, the reputation system is actually decentralized—even though it appears on the surface to be managed only by authorized APs. This is thus a material improvement over centralized database reputation systems that don't maintain the provenance of votes/reviews/endorsements. Note that such audits do not necessarily require the AP to disclose potentially confidential analytics algorithms that are used to generate updated reputation scores that are based, at least in part, on peer-contributed inputs. Unlike other systems that may be denoted as entirely or at least primarily “self-sovereign” systems, the embodiment of the reputation system of the current invention is not necessarily limited to invocation within use cases that are self-contained within the blockchain activity (such as related, for example, to determining which nodes operated legitimately and effectively when participating in file sharing, as file sharers and/or recipients of shared files (where recipients might be expected to reciprocate or pay via cryptocurrency or other means)). Rather, the invention builds on inherited/imported reputation scoring that is based on inputs by preferably trusted sources. Such trusted source inputs may include aspects of preferably secure provisioning of end nodes/devices. The inputs/assertions may be sourced by Identity Providers (IdP) and/or Attribute Authorities/Authorization Authorities (AA) that exist independently of the blockchain framework. When peer entities vote on one another, there may be a chaining effect, in that the reputations score(s) of the user or device that is voting can be taken into account as a weighted vote by the analytics processing algorithm(s). User/device nodes need not expose any long-term/static identifiers to peer nodes in order to participate in the voting process as endorser nodes or as endorsed nodes. An appropriately authorized AP (in possession of the relevant cryptographic keying material) can determine the identities of those nodes within its jurisdiction, so as to accurately assess reputation, and not be subject to Sybil attacks whereby a single node attempts to present itself as multiple nodes in order to illegitimately skew the voting process. By enabling nodes to present/expose only short-term or one-time-use identifiers/persona to one another, privacy and resilience against unintended traffic analysis is preserved. For nodes that are mobile, rather than stationary, this can prevent leakage regarding which nodes other nodes might avoid because they suspect that their reputation scores were lowered as a result of interaction with such specific nodes. This offers increased resistance against hacked nodes effectively gaming the system.

### Further Embodiments

The reputation system (and corresponding method described in the figures and embodiments above) is not limited to assessing and disseminating just user behavior, but device behavior as well. This can be used to assess which devices (or users) should be revoked, or be trusted on only a limited basis (such as for non-critical tasks). This aids in revocation of devices that have been hacked and are no longer performing legitimately, even if they are known to have been originally sourced and provisioned as legitimate devices from a recognized manufacturer. Further, beyond consideration of individual suspect devices, this may aid in the detection of software or firmware versions that are buggy or that have been maliciously modified prior to distribution or provisioning. This may be considered an extension of remote attestation methods that help to determine if a given device is running the latest version of software and/or firmware and/or has been properly hardware-configured.

Reputation plays an essential role in determining which users/devices to trust as potential recipients of certain types of information/data, as well as in determining which users/devices to trust when receiving information/data from them. Reputation scores/metrics may pertain to a user/device as a whole, or to specific asserted attributes. This has the effect, for example, of a pacemaker device only accepting recalibration commands from an entity that is authorized for such functionality and that is in current good standing.

The “permissioning” aspects of the system can be used during blockchain validation and consensus operations, where validation can be used to determine the legitimacy of the transacting entities relative to the specifics of the transactions, and consensus is used to agree on the incorporation of transactions into blocks. This is unlike a “permissionless” system such as that of the IOTA Foundation that treats all participating nodes the same.

Use Cases (Solutions of which can Leverage Blockchain-Assured Identity and Attributes Management)

Supply chain management (e.g., enabling efficient/timely/targeted product recall; blockchain transactions handled via mobile device apps and/or dedicated portable/stationary facility-provided communications equipment);

Physical assets tracking (virtual representation of original sourcing, and changes in ownership/custody/location);

Renewable energy management (including automated scheduling of appliance usage to avoid peak-demand pricing surcharges, and managing residential/commercial sales back to the grid);

Scheduled (controlled) access to shared physical assets (e.g., vehicles, buildings, equipment kiosks);

Data collection and access management (e.g., to meet compliance with General Data Protection Regulation (GDPR) requirements or other data privacy regulations);

On-chain setup/reporting of off-chain activities (accommodates resource-constrained devices that don't directly transact on the blockchain; provides cryptographic binding of blockchain transactions to off-chain communications; accounts for authorized remote activation/utilization of IoT devices);

Reputation/voting/endorsement systems (privacy-preserving, Sybil-attack-resistant and authorized reputation scoring—aids, in particular, in determining which users should have privileges revoked or modified);

Service setup/fulfillment transactions aggregation for payment processing efficiency and overall scalability;

Opt-in tracking of mobile device usage (e.g., enabling more efficient/effective/convenient cross-carrier utilization and payments, more responsive targeted advertising, and attractive new services offerings predicated on analysis of collected device usage data);

Remote document notarization;

Sequenced (with mutually-trusted time stamps) generation/negotiation/modification/initialing and signing of multi-party offers and contracts (or other collaboratively-generated works such as consumer-produced/user-generated content);

Cross-device access (enabling users to securely claim ownership of transactions via different devices for convenience as well as continuity in the case of device replacement; also accommodates changes in membership of user groups);

First responders (prioritization of message traffic and rerouting of vehicular traffic to clear communications channels and roadways for effective dispatch of emergency services);

Allocating and tracking equipment (such as which shift employees utilized which rack equipment during which time periods);

Identity-fraud prevention/mitigation that reduces adversarial advantage of breaching PII databases (dynamic identifiers proven through selective disclosure of corroborated blockchain transaction activity).

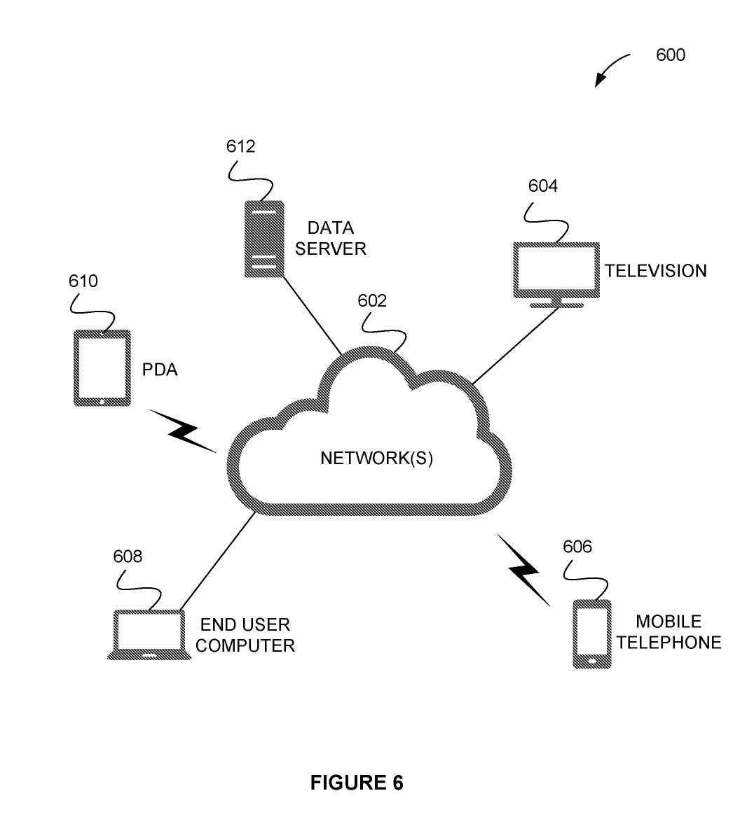

FIG. 6 illustrates a network architecture 600, in accordance with one embodiment. As shown, at least one network 602 is provided. In various embodiments, any one or more components/features set forth during the description of any previous figure(s) may be implemented in connection with any one or more of the components of the at least one network 602.

In the context of the present network architecture 600, the network 602 may take any form including, but not limited to a telecommunications network, a local area network (LAN), a wireless network, a wide area network (WAN) such as the Internet, peer-to-peer network, cable network, etc. While only one network is shown, it should be understood that two or more similar or different networks 602 may be provided.

Coupled to the network 602 is a plurality of devices. For example, a server computer 612 and an end user computer 608 may be coupled to the network 602 for communication purposes. Such end user computer 608 may include a desktop computer, lap-top computer, and/or any other type of logic. Still yet, various other devices may be coupled to the network 602 including a personal digital assistant (PDA) device 610, a mobile phone device 606, a television 604, etc.

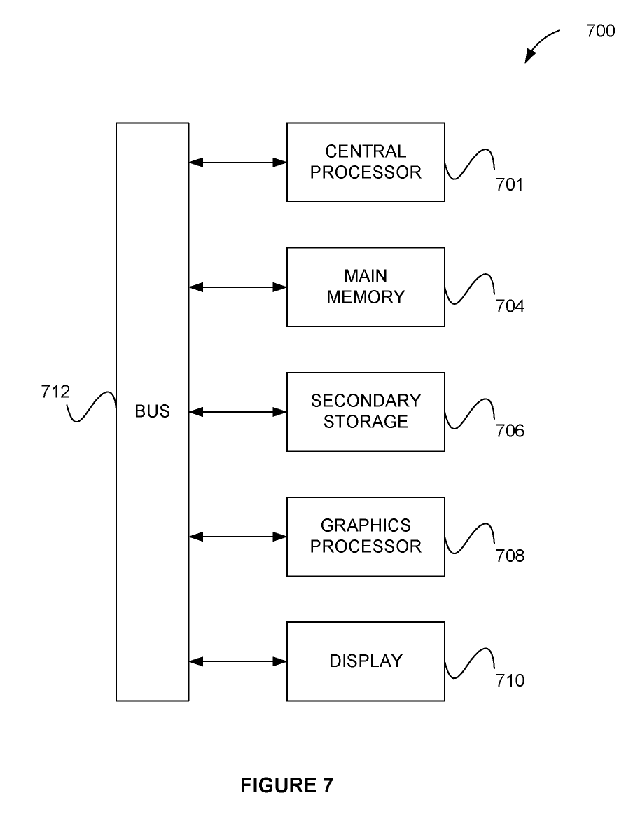

FIG. 7 illustrates an exemplary system 700, in accordance with one embodiment. As an option, the system 700 may be implemented in the context of any of the devices of the network architecture 600 of FIG. 6. However, it is to be appreciated that the system 700 may be implemented in any desired environment.

As shown, a system 700 is provided including at least one central processor 702 which is connected to a bus 712. The system 700 also includes main memory 704 [e.g., hard disk drive, solid state drive, random access memory (RAM), etc.]. The system 700 also includes a graphics processor 708 and a display 710.

The system 700 may also include a secondary storage 706. The secondary storage 706 includes, for example, a hard disk drive and/or a removable storage drive, representing a floppy disk drive, a magnetic tape drive, a compact disk drive, etc. The removable storage drive reads from and/or writes to a removable storage unit in a well-known manner.

Computer programs, or computer control logic algorithms, may be stored in the main memory 704, the secondary storage 706, and/or any other memory, for that matter. Such computer programs, when executed, enable the system 700 to perform various functions (as set forth above, for example). Memory 704, secondary storage 706 and/or any other storage are possible examples of non-transitory computer-readable media.

In one embodiment, means in the form of the processor 702 (and/or different means corresponding to different components thereof) executes instructions in the memory 704 or in the secondary storage 706 to: access a transaction submitted within a blockchain or distributed ledger, the transaction being submitted for provisioning a service that requires payment; extract, from the transaction, one or more assertions of device or user attributes that are verifiably associated with at least one party to the transaction; and validate the transaction, utilizing the device or user attributes, independently of processing the payment.

Optionally, in any of the preceding embodiments, the transaction is a request for the provisioning of the service.

Optionally, in any of the preceding embodiments, the transaction is a response to a request for the provisioning of the service.

Optionally, in any of the preceding embodiments, the at least one party to the transaction is a creator of the transaction.

Optionally, in any of the preceding embodiments, the at least one party to the transaction is an intended recipient of the transaction.

Optionally, in any of the preceding embodiments, the at least one party to the transaction is a counterparty to the transaction.

Optionally, in any of the preceding embodiments, validating the transaction includes comparing the device or user attributes to one or more stipulations. As a further option, the one or more stipulations are set by at least one of the transaction, a prior transaction submitted within the blockchain or distributed ledger, and a policy.

Optionally, in any of the preceding embodiments, one or more of the device or user attributes are reputation scores. Such reputation scores may act to qualify certain other device or user attributes rather than the device or user as a whole.

Optionally, in any of the preceding embodiments, the processor 702 (and/or different means corresponding to different components thereof) executes the instructions in the memory 704 or in the secondary storage 706 to further: access a second transaction submitted within the blockchain or distributed ledger, the second transaction being submitted for processing the payment and including updating a state associated with at least one source account and at least one sink account; and process the second transaction. As a further option, the at least one source account and the at least one sink account are identifiable via one or more assertions of device or user attributes that are verifiably associated with at least one party to the second transaction.

Optionally, in any of the preceding embodiments, the blockchain or distributed ledger is a permissioned blockchain or distributed ledger, and the processor 702 (and/or different means corresponding to different components thereof) executes the instructions in the memory 704 or in the secondary storage 706 to further: access a second transaction submitted within a permissionless blockchain or distributed ledger, the second transaction being submitted for processing the payment; and process the second transaction. As a further option, the permissionless blockchain or distributed ledger includes a native cryptocurrency usable for processing the payment.

Optionally, in any of the preceding embodiments, validators verify through message authentication code computation guesses of the device or user attributes via selective release by a creator of the transaction of integrity keys for the device or user attributes.

Optionally, in any of the preceding embodiments, validators recover through decryption the device or user attributes via selective release by a creator of the transaction of encryption keys for the device or user attributes.

Optionally, in any of the preceding embodiments, validators recover through decryption the device or user attributes via recovery of encryption keys through knowledge of audit-level keys.

Optionally, in any of the preceding embodiments, the processor 702 (and/or different means corresponding to different components thereof) executes the instructions in the memory 704 or in the secondary storage 706 to further: receive votes or reviews for the device or user; cluster the transaction with other transactions; allow transactions within the cluster to be distinguished, using a key, by at least one of: originating device or user from a plurality of devices or users, or votes or reviews referring to a same device or user from the plurality of devices or users. As a further option, each device or user in the plurality of devices or users exhibits a one-time user persona to the other devices or users in the plurality of devices or users in lieu of static identifiers.

It is noted that the techniques described herein, in an aspect, are embodied in executable instructions stored in a computer readable medium for use by or in connection with an instruction execution machine, apparatus, or device, such as a computer-based or processor-containing machine, apparatus, or device. It will be appreciated by those skilled in the art that for some embodiments, other types of computer readable media are included which may store data that is accessible by a computer, such as magnetic cassettes, flash memory cards, digital video disks, Bernoulli cartridges, random access memory (RAM), read-only memory (ROM), and the like.

As used here, a “computer-readable medium” includes one or more of any suitable media for storing the executable instructions of a computer program such that the instruction execution machine, system, apparatus, or device may read (or fetch) the instructions from the computer readable medium and execute the instructions for carrying out the described methods. Suitable storage formats include one or more of an electronic, magnetic, optical, and electromagnetic format. A non-exhaustive list of conventional exemplary computer readable medium includes: a portable computer diskette; a RAM; a ROM; an erasable programmable read only memory (EPROM or flash memory); optical storage devices, including a portable compact disc (CD), a portable digital video disc (DVD), a high definition DVD (HD-DVD™), a BLU-RAY disc; and the like.

It should be understood that the arrangement of components illustrated in the Figures described are exemplary and that other arrangements are possible. It should also be understood that the various system components (and means) defined by the claims, described below, and illustrated in the various block diagrams represent logical components in some systems configured according to the subject matter disclosed herein.

For example, one or more of these system components (and means) may be realized, in whole or in part, by at least some of the components illustrated in the arrangements illustrated in the described Figures. In addition, while at least one of these components are implemented at least partially as an electronic hardware component, and therefore constitutes a machine, the other components may be implemented in software that when included in an execution environment constitutes a machine, hardware, or a combination of software and hardware.

More particularly, at least one component defined by the claims is implemented at least partially as an electronic hardware component, such as an instruction execution machine (e.g., a processor-based or processor-containing machine) and/or as specialized circuits or circuitry (e.g., discreet logic gates interconnected to perform a specialized function). Other components may be implemented in software, hardware, or a combination of software and hardware. Moreover, some or all of these other components may be combined, some may be omitted altogether, and additional components may be added while still achieving the functionality described herein. Thus, the subject matter described herein may be embodied in many different variations, and all such variations are contemplated to be within the scope of what is claimed.

In the description above, the subject matter is described with reference to acts and symbolic representations of operations that are performed by one or more devices, unless indicated otherwise. As such, it will be understood that such acts and operations, which are at times referred to as being computer-executed, include the manipulation by the processor of data in a structured form. This manipulation transforms the data or maintains it at locations in the memory system of the computer, which reconfigures or otherwise alters the operation of the device in a manner well understood by those skilled in the art. The data is maintained at physical locations of the memory as data structures that have particular properties defined by the format of the data. However, while the subject matter is being described in the foregoing context, it is not meant to be limiting as those of skill in the art will appreciate that various of the acts and operations described hereinafter may also be implemented in hardware.

To facilitate an understanding of the subject matter described herein, many aspects are described in terms of sequences of actions. At least one of these aspects defined by the claims is performed by an electronic hardware component. For example, it will be recognized that the various actions may be performed by specialized circuits or circuitry, by program instructions being executed by one or more processors, or by a combination of both. The description herein of any sequence of actions is not intended to imply that the specific order described for performing that sequence must be followed. All methods described herein may be performed in any suitable order unless otherwise indicated herein or otherwise clearly contradicted by context.

The use of the terms “a” and “an” and “the” and similar referents in the context of describing the subject matter (particularly in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. Furthermore, the foregoing description is for the purpose of illustration only, and not for the purpose of limitation, as the scope of protection sought is defined by the claims as set forth hereinafter together with any equivalents thereof entitled to. The use of any and all examples, or exemplary language (e.g., “such as”) provided herein, is intended merely to better illustrate the subject matter and does not pose a limitation on the scope of the subject matter unless otherwise claimed. The use of the term “based on” and other like phrases indicating a condition for bringing about a result, both in the claims and in the written description, is not intended to foreclose any other conditions that bring about that result. No language in the specification should be construed as indicating any non-claimed element as essential to the practice of the invention as claimed.

The embodiments described herein include the one or more modes known to the inventor for carrying out the claimed subject matter. It is to be appreciated that variations of those embodiments will become apparent to those of ordinary skill in the art upon reading the foregoing description. The inventor expects skilled artisans to employ such variations as appropriate, and the inventor intends for the claimed subject matter to be practiced otherwise than as specifically described herein. Accordingly, this claimed subject matter includes all modifications and equivalents of the subject matter recited in the claims appended hereto as permitted by applicable law. Moreover, any combination of the above-described elements in all possible variations thereof is encompassed unless otherwise indicated herein or otherwise clearly contradicted by context.

What is claimed is:

1. A method for validating blockchain or distributed ledger transactions in a service requiring payment, comprising:
receiving, by a proxy, a request from a first entity to create and submit a transaction to a blockchain or distributed ledger on behalf of the first entity, as a response to a request for the provisioning of a service requiring payment, where the request identifies a second entity as an intended recipient of the transaction;
before submitting the transaction to the blockchain or distributed ledger, preliminarily validating the request, by the proxy;
responsive to preliminarily validating the request with an affirmative result, submitting the created transaction to the blockchain or distributed ledger, by the proxy;
wherein responsive to the proxy submitting the created transaction to the blockchain or distributed ledger, the transaction is validated independently of processing the payment.

2. The method of claim 1, wherein preliminarily validating the request includes:
acquiring, by the proxy, information comprised of a transaction certificate owned by the second entity.

3. The method of claim 2, wherein the information additionally includes one or more keys that selectively release certain attributes of the transaction certificate owned by the second entity.

4. The method of claim 2, wherein the information is acquired by the proxy via retrieval from another transaction within the blockchain or distributed ledger.

5. The method of claim 1, wherein the transaction is validated independently of processing the payment by:
checking, by a validator, one or more attributes of the second entity as the intended recipient of the transaction submitted by the proxy.

6. The method of claim 1, wherein the transaction is validated independently of processing the payment by:
checking, by a validator, one or more attributes of the proxy as creator of the transaction submitted to the blockchain or distributed ledger.

7. The method of claim 1, wherein the created transaction indicates a third entity as an additional intended recipient of the transaction.

8. A non-transitory computer readable medium storing computer code executable by a processor to perform a method comprising:
receiving, by a proxy, a request from a first entity to create and submit a transaction to a blockchain or distributed ledger on behalf of the first entity, as a response to a request for the provisioning of a service requiring payment, where the request identifies a second entity as an intended recipient of the transaction;
before submitting the transaction to the blockchain or distributed ledger, preliminarily validating the request, by the proxy;
responsive to preliminarily validating the request with an affirmative result, submitting the created transaction to the blockchain or distributed ledger, by the proxy;
wherein responsive to the proxy submitting the created transaction to the blockchain or distributed ledger, the transaction is validated independently of processing the payment.

9. The non-transitory computer readable medium of claim 8, wherein preliminarily validating the request includes:
acquiring, by the proxy, information comprised of a transaction certificate owned by the second entity.

10. The non-transitory computer readable medium of claim 9, wherein the information additionally includes one or more keys that selectively release certain attributes of the transaction certificate owned by the second entity.

11. The non-transitory computer readable medium of claim 9, wherein the information is acquired by the proxy via retrieval from another transaction within the blockchain or distributed ledger.

12. The non-transitory computer readable medium of claim 8, wherein the transaction is validated independently of processing the payment by:
checking, by a validator, one or more attributes of the second entity as the intended recipient of the transaction submitted by the proxy.

13. The non-transitory computer readable medium of claim 8, wherein the transaction is validated independently of processing the payment by:
checking, by a validator, one or more attributes of the proxy as creator of the transaction submitted to the blockchain or distributed ledger.

14. The non-transitory computer readable medium of claim 8, wherein the created transaction indicates a third entity as an additional intended recipient of the transaction.

15. An apparatus, comprising:
a memory storing instructions, and
a computer processor executing the instructions for:
receiving, by a proxy, a request from a first entity to create and submit a transaction to a blockchain or distributed ledger on behalf of the first entity, as a response to a request for the provisioning of a service requiring payment, where the request identifies a second entity as an intended recipient of the transaction;
before submitting the transaction to the blockchain or distributed ledger, preliminarily validating the request, by the proxy;
responsive to preliminarily validating the request with an affirmative result, submitting the created transaction to the blockchain or distributed ledger, by the proxy;
wherein responsive to the proxy submitting the created transaction to the blockchain or distributed ledger, the transaction is validated independently of processing the payment.

16. The apparatus of claim 15, wherein preliminarily validating the request includes:
acquiring, by the proxy, information comprised of a transaction certificate owned by the second entity.

17. The apparatus of claim 16, wherein the information additionally includes one or more keys that selectively release certain attributes of the transaction certificate owned by the second entity.

18. The apparatus of claim 16, wherein the information is acquired by the proxy via retrieval from another transaction within the blockchain or distributed ledger.

19. The apparatus of claim 15, wherein the transaction is validated independently of processing the payment by:
checking, by a validator, one or more attributes of the second entity as the intended recipient of the transaction submitted by the proxy.

20. The apparatus of claim 15, wherein the transaction is validated independently of processing the payment by:
checking, by a validator, one or more attributes of the proxy as creator of the transaction submitted to the blockchain or distributed ledger.

21. The apparatus of claim 15, wherein the created transaction indicates a third entity as an additional intended recipient of the transaction.
